(19) United States
(12) Patent Application Publication
(10) Pub. No.: US 2025/0304009 A1
(43) Pub. Date: Oct. 2, 2025

(54) ENTRY SYSTEM AND AUTHENTICATION METHOD

(71) Applicant: HONDA MOTOR CO., LTD., Tokyo (JP)

(72) Inventors: Naoto Yamamoto, Tokyo (JP); Takashi Kubo, Tokyo (JP); Seonghun Lee, Tokyo (JP); Kohji Kawaura, Tokyo (JP)

(21) Appl. No.: 19/060,158

(22) Filed: Feb. 21, 2025

(30) Foreign Application Priority Data
Mar. 29, 2024 (JP) 2024-055947

(51) Int. Cl. B60R 25/25; B60R 25/30; B60R 25/31; E05B 81/56; E05F 15/73; G06V 20/58; G06V 40/16; H04N 23/71; H04N 23/73

(52) U.S. Cl. CPC B60R 25/25; B60R 25/305; B60R 25/31; G06V 20/58; G06V 40/172; H04N 23/71; H04N 23/73; E05B 81/56; E05F 15/73; E05F 2015/767; E05Y 2900/531

(57) ABSTRACT

An entry system includes: a detection unit configured to detect a target person approaching a moving body; and an authentication unit configured to authenticate that the target person is a registered user based on a face image of the target person, and the detection unit measures illuminance around the moving body when an object which has entered a range of a prescribed distance from the moving body is detected, and selects a sensor to be used to determine whether or not the object is the target person according to the illuminance.

### INCORPORATION BY REFERENCE

The present application claims priority under 35 U.S.C. § 119 to Japanese Patent Application No. 2024-055947 filed on Mar. 29, 2024. The content of the application is incorporated herein by reference in its entirety.

### BACKGROUND OF THE INVENTION

### Field of the Invention

The present invention relates to an entry system and an authentication method.

### Description of the Related Art

In recent years, an approach of providing access to a sustainable transportation system considering even vulnerable people like aged people, people with disabilities and children among traffic participants is gaining momentum. Towards the realization, the focus is on research and development for further improving traffic safety and convenience through development regarding vehicle accessibility.

Japanese Patent Laid-Open No. 2022-133769 discloses a vehicle controller that performs object detection and person detection after determining illuminance of a surrounding environment. In the vehicle controller, when it is determined that a vehicle environment is a dark place by a power-saving camera or an illuminance sensor or the like, an LED and a high accuracy camera are activated when a motion sensor detects an object, and whether or not the object is a person is detected. Thus, even in the dark environment, power consumption of an onboard camera is suppressed, and a target person present around a vehicle can be accurately authenticated.

Now, for vehicle accessibility, a problem is to appropriately authenticate a user trying to get on a vehicle even in a dark place.

In the above conventional technology, it is needed to operate the power-saving camera and the illuminance sensor or the like at all times in order to determine the illuminance and the person detection is performed using the high accuracy camera of large power consumption whether it is dark or not so that there is further room for improvement in terms of power consumption.

In order to solve the above-described problem, an object of the present application is to appropriately authenticate a user who intends to perform entry into a moving body even in a dark place while suppressing power consumption, thereby contributing to development of a sustainable transportation system.

### SUMMARY OF THE INVENTION

One mode of the present invention aspect is an entry system including: a detection unit configured to detect a target person approaching a moving body; and an authentication unit configured to authenticate that the target person is a registered user based on a face image of the target person. The detection unit measures illuminance around the moving body when an object which has entered a range of a prescribed distance from the moving body is detected, and selects a sensor to be used to determine whether or not the object is the target person according to the illuminance.

Another mode of the present invention aspect is an authentication method conducted by a computer of an entry system which authenticates a target person approaching a moving body, and the method includes: a detection step of detecting the target person approaching the moving body; and an authentication step of authenticating that the target person is a registered user based on a face image of the target person. In the detection step, illuminance around the moving body is measured when an object which has entered a range of a prescribed distance from the moving body is detected, and a sensor to be used to determine whether or not the object is the target person is selected according to the illuminance.

According to the present invention aspect, a user who intends to perform entry into a moving body can be appropriately authenticated even in a dark place while suppressing power consumption.

### BRIEF DESCRIPTION OF THE DRAWINGS

FIG. 1 is a diagram illustrating an example of a configuration of a moving body loaded with an entry system according to one embodiment of the present invention;

FIG. 2 is a diagram illustrating a configuration of the entry system;

FIG. 3 is an explanatory diagram for describing an operation of the entry system in a dark place;

FIG. 4 is an explanatory diagram for describing an operation of the entry system in a bright place; and

FIG. 5 is a flowchart illustrating a procedure of an operation in the entry system.

### DETAILED DESCRIPTION OF THE INVENTION

Hereinafter, an embodiment of the present invention will be described with reference to the drawings.

### [1. Configuration of Vehicle]

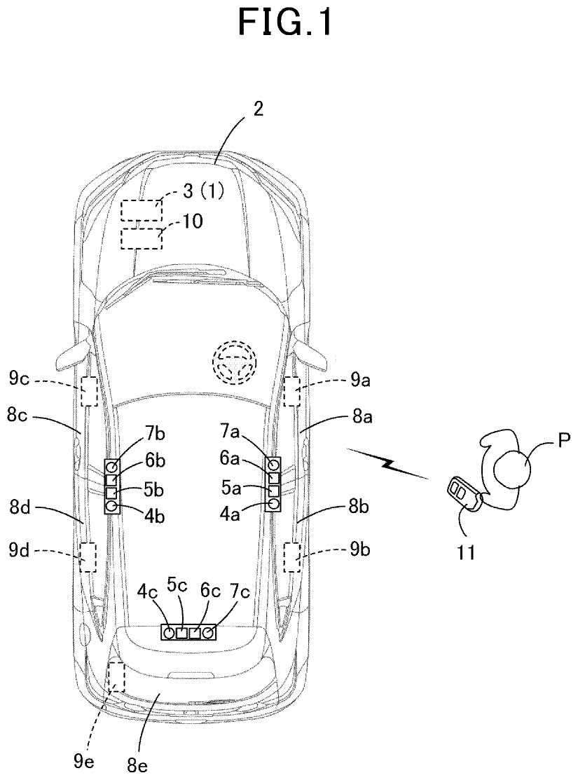

FIG. 1 is a diagram illustrating a configuration of a moving body 2 loaded with an entry system 1 of the present embodiment. The moving body 2 includes an entry controller 3 forming the entry system 1. The entry system 1 is loaded in the moving body 2, authenticates a target person P who is an arbitrary person who intends to perform entry into the moving body 2, and enables utilization of the moving body 2 by the target person P when it is authenticated that the target person P is a person who has proper authority to utilize the moving body 2. Here, “entry” to the moving body 2 refers at least to boarding (or getting into) the moving body 2 from outside of the moving body 2, and may further include starting utilization of a system of the moving body 2 by login or the like to the system after boarding.

In the present embodiment, the moving body 2 is, for example, a passenger car, and may be a shared car that a plurality of persons can board. Yet, the moving body 2 is not limited to a passenger car, and may be an arbitrary moving body. Such a moving body may be, in addition to a land moving body such as a passenger car, a bus, a taxi, and a train, a marine moving body such as a ship and a submarine, or an air moving body such as an aircraft including an eVTOL (Electric Vertical Take-Off and Landing aircraft) and an airship.

On a right side part of the moving body 2, a right ranging sensor 4a that detects an object present on a right side of the moving body 2, a first right camera 5a and a second right camera 6a that photograph the right side of the moving body 2, and a right illuminator 7a that illuminates the right side of the moving body 2 are provided.

On a left side part of the moving body 2, a left ranging sensor 4b that detects an object present on a left side of the moving body 2, a first left camera 5b and a second left camera 6b that photograph the left side of the moving body 2, and a left illuminator 7b that illuminates the left side of the moving body 2 are provided.

On a rear part of the moving body 2, a rear ranging sensor 4c that detects an object present in a rear of the moving body 2, a first rear camera 5c and a second rear camera 6c that photograph the rear of the moving body 2, and a rear illuminator 7c that illuminates the rear of the moving body 2 are provided.

Hereinafter, the right ranging sensor 4a, the left ranging sensor 4b, and the rear ranging sensor 4c are noted as a ranging sensor 4 when not to be distinguished. In addition, the first right camera 5a, the first left camera 5b, and the first rear camera 5c are noted as a first camera 5 when not to be distinguished. Further, the second right camera 6a, the second left camera 6b, and the second rear camera 6c are noted as a second camera 6 when not to be distinguished. Also, the right illuminator 7a, the left illuminator 7b, and the rear illuminator 7c are noted as an illuminator 7 when not to be distinguished.

The second camera 6 has higher resolution and power consumption as compared with the first camera 5.

The first camera 5 and the second camera 6 are, for example, CCD cameras having different pixel numbers. In addition, the ranging sensor 4 is, for example, an arbitrary sensor capable of detecting a surrounding object and measuring a distance to the object. In the present embodiment, the ranging sensor 4 is a radar, and is more specifically a millimeter wave radar. The ranging sensor 4 may be, in addition to a radar, a LiDar, or a sonar or the like, for example.

The illuminator 7 illuminates an imaging range of the second camera 6. The illuminator 7 can be formed using an arbitrary light emitter or light emitting element, for example. In the present embodiment, the illuminator 7 is, for example, an LED projector.

The moving body 2 also includes a door switch 9 provided in each of doors 8 of the moving body 2 to lock and unlock a door lock of the door 8 and to open and close the door 8. The door switch 9 may include an actuator that locks and unlock the door lock of the corresponding door 8 and an actuator that opens and closes the door 8.

In the present embodiment, the moving body 2 includes, as the doors 8 and the door switches 9, a right front door switch 9a provided on a driver's seat door 8a at a right front of the moving body 2, and a right rear door switch 9b provided on a right rear seat door 8b at a right rear of the moving body 2. In addition, the moving body 2 includes a left front door switch 9c provided on a passenger seat door 8c at a left front of the moving body 2, and a left rear door switch 9d provided on a left rear seat door 8d at a left rear of the moving body 2. The moving body 2 further includes a back door switch 9e provided on a back door (tailgate door) 8e of the moving body 2.

The moving body 2 also includes a communication device 10. The communication device 10 includes a transmitter-receiver for communicating with an electronic key 11 used to utilize the moving body 2. The electronic key 11 may be, for example, a smart key such as a FOB key, or a portable terminal such as a smartphone storing key information used to utilize the moving body 2.

### [2. Configuration of Entry System]

The configuration of the entry system 1 will be described.

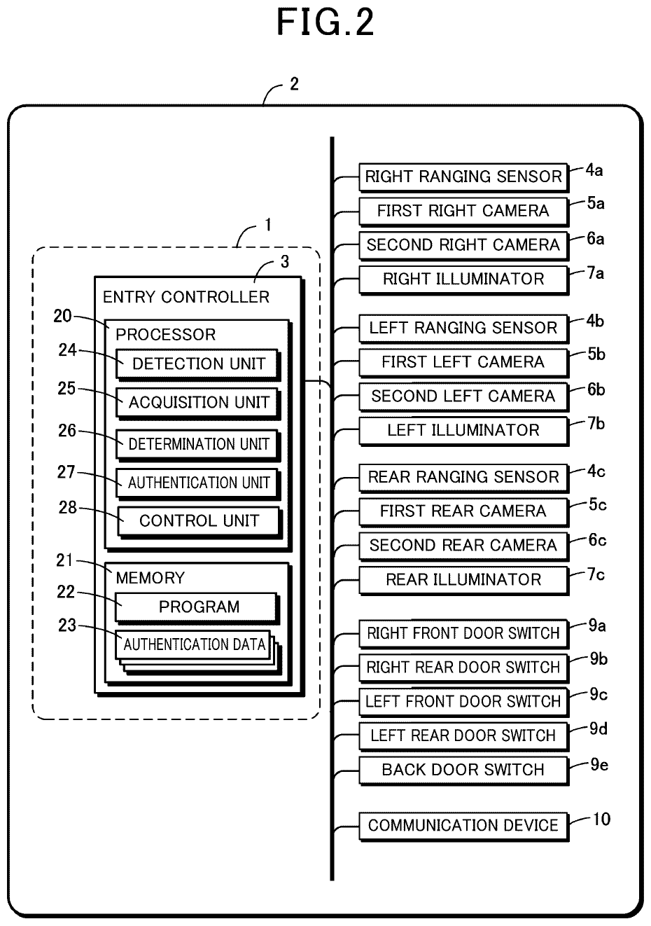

FIG. 2 is a diagram illustrating the configuration of the entry system 1. The entry system 1 at least includes the entry controller 3. The entry controller 3 authenticates the target person P who is an arbitrary person who intends to perform entry into the moving body 2, and enables the utilization of the moving body 2 by the target person P when the target person P is authenticated. The authentication is conducted based on a face image acquired for the target person P.

Note that, hereinafter, a “target person” is a person defined as a target of the authentication by the entry system 1. In addition, a “user” is a registered user registered beforehand as a person who has proper authority to utilize the moving body 2, and is a person who actually utilizes the moving body 2. The target person P becomes the user when the target person P is authenticated by the entry controller 3 and the utilization of the moving body 2 is enabled.

Some of functional elements of the entry controller 3 indicated below may be provided in another device. For example, a control unit 28 (to be described later) provided in the entry controller 3 may be realized as a functional element of an electronic control unit (ECU) that controls an operation of the moving body 2. In this case, the entry system 1 includes the entry controller 3 and the electronic control unit, and the entry controller 3 communicates with the electronic control unit, and makes a function of the control unit 28 be executed in the electronic control unit.

The entry system 1 may also include other instruments such as the ranging sensor 4, the first camera 5 and the second camera 6 used by the entry controller 3.

The entry controller 3 includes a processor 20 and a memory 21. The memory 21 is formed of, for example, a volatile or nonvolatile semiconductor memory and/or a hard disk device or the like. In the memory 21, authentication data 23 is preserved for each of one, two or more registered users registered beforehand as persons who have the proper authority to utilize the moving body 2.

The processor 20 is a computer including a CPU or the like, for example. The processor 20 may include a ROM in which a program is written, and a RAM for temporarily storing data or the like. Then, the processor 20 includes, as the functional elements or functional units, a detection unit 24, an acquisition unit 25, a determination unit 26, an authentication unit 27, and the control unit 28.

The functional elements provided in the processor 20 are realized by the processor 20 which is a computer executing a program 22 preserved in the memory 21. Note that the program 22 can be stored in an arbitrary computer-readable storage medium. Instead, all or some of the functional elements provided in the processor 20 may be formed of hardware including one or more electronic circuit components, respectively.

The detection unit 24 uses the ranging sensor 4 and the first camera 5 to detect the target person P approaching the moving body 2. In the present embodiment, in particular, the detection unit 24 measures illuminance around the moving body 2 when an object which enters a prescribed distance range from the moving body 2 is detected. Then, the detection unit 24 selects a sensor to be used to determine whether or not the object is the target person according to the illuminance.

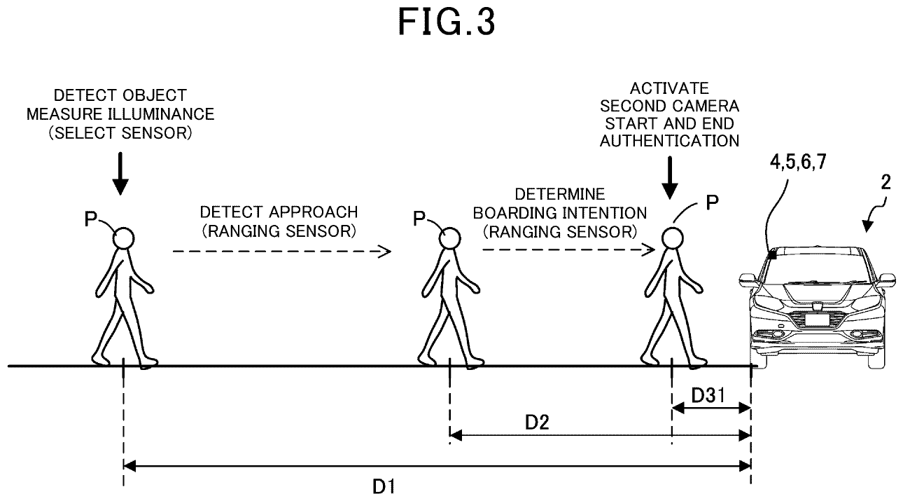

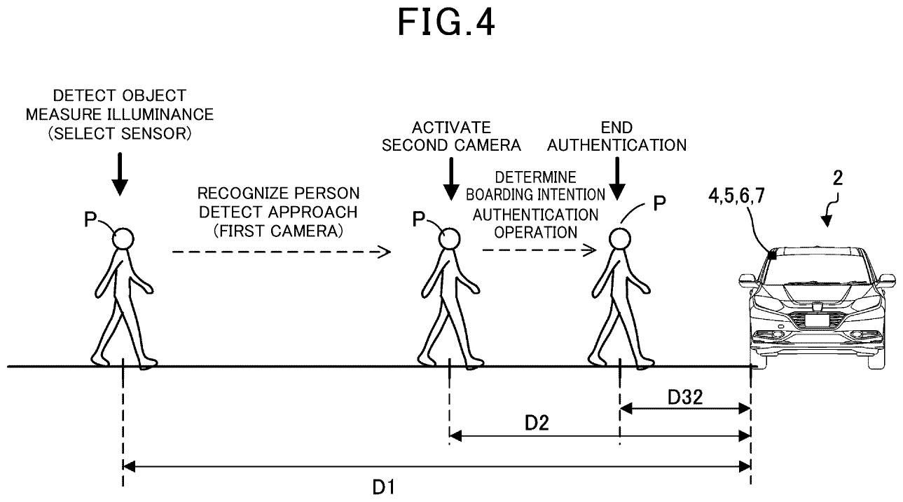

The detection unit 24 is operated as illustrated in FIG. 3 and FIG. 4, for example. FIG. 3 is an explanatory diagram for describing the operation in a dark place. In addition, FIG. 4 is an explanatory diagram for describing the operation in a bright place.

The detection unit 24 first determines whether or not an entity (or an object) has entered a range of a prescribed distance D1 determined beforehand from the moving body 2 by the ranging sensor 4. The entity may be an arbitrary object including a living thing and a nonliving thing. When the entity has entered the range of the prescribed distance D1, the detection unit 24 activates the first camera 5 close to the ranging sensor 4 which has detected the entity. The detection unit 24 measures the illuminance around the moving body 2 by the activated first camera 5.

Then, when the illuminance around the moving body 2 is lower than a first prescribed value determined beforehand (see FIG. 3), the detection unit 24 selects the ranging sensor 4 as a sensor to be used to determine whether or not the object detected by the ranging sensor 4 is the target person P. The detection unit 24 repeatedly acquires a distance from the moving body 2 to the object at a prescribed time interval determined beforehand by the ranging sensor 4. Then, when a moving speed of the object is within a prescribed range determined beforehand and a distance between the object and the moving body 2 is decreasing with time based on the acquired distance at the prescribed time interval, the detection unit 24 determines that the object is the target person P.

On the other hand, when the illuminance around the moving body 2 is equal to or higher than the first prescribed value (see FIG. 4), the detection unit 24 selects the first camera 5 as a sensor to be used to determine whether or not the object is the target person P. At the time, when the illuminance around the moving body 2 is equal to or higher than a second prescribed value determined beforehand, the detection unit 24 may change (or adjust) exposure setting of the first camera 5 so as not to generate blown out highlights in an image acquired from the first camera 5.

The detection unit 24 repeatedly acquires the image of the object by the first camera 5 at the prescribed time interval determined beforehand. The detection unit 24 performs image recognition processing for each of the images acquired at the prescribed time interval, determines whether or not the object is a person, and also specifies a moving direction of the person. Then, when it can be recognized that the object is a person at a predetermined frequency and it is determined that the object recognized as a person is moving in a direction of approaching the moving body 2, the detection unit 24 determines that the object is the target person P.

In both examples illustrated in FIG. 3 and FIG. 4, the detection unit 24 determines that the entity is the target person P approaching the moving body 2 while the entity detected by the ranging sensor 4 at the position at the distance D1 advances to the position at a distance D2, and notifies the determination unit 26 and the authentication unit 27 of that the target person P is detected when the target person P reaches the position at the distance D2.

At the time, in a case where the illuminance is equal to or higher than the first prescribed value and approach of the target person P is detected using the first camera 5, the detection unit 24 may notify the determination unit 26 of the number of times of not recognizing that the detected object is a person in the image recognition processing for the plurality of images acquired from the first camera 5 at the prescribed time interval.

The acquisition unit 25 acquires a high-definition image of the target person P by the second camera 6 in response to reception of an image acquisition instruction from the determination unit 26 and/or the authentication unit 27 to be described later. As described above, the second camera 6 has higher resolution and power consumption as compared with the first camera 5.

Specifically, the acquisition unit 25 activates the second camera 6 near the first camera 5 used to detect the target person P, and acquires a second image of the target person P by the activated second camera 6 at the prescribed time interval. When the illuminance around the moving body 2 is lower than the first prescribed value, the acquisition unit 25 may light the illuminator 7 near the activated second camera 6. The acquisition unit 25 successively photographs the high-definition second image of the target person P by the activated second camera 6 at the prescribed time interval.

The acquisition unit 25 extracts the face image of the target person P from the second image every time the second image of the target person P is photographed, and acquires the plurality of face images of the target person P captured at the prescribed time interval. Every time the second image of the target person P is photographed, the acquisition unit 25 sends the photographed image of the target person P and the extracted face image to the determination unit 26 and the authentication unit 27 which are transmission sources of the image acquisition instruction, respectively.

The determination unit 26 determines presence/absence of an intention of the target person P to board the moving body 2.

When the illuminance around the moving body 2 measured by the detection unit 24 is equal to or higher than the first prescribed value (see FIG. 4), the determination unit 26 transmits the image acquisition instruction to the acquisition unit 25 to make the acquisition unit 25 acquire the second image of the target person P when a notice indicating that the target person P is detected is received from the detection unit 24. As described above, the acquisition unit 25 repeatedly acquires the second image of the target person P by the second camera 6 at the prescribed time interval.

The determination unit 26 determines the presence/absence of the intention of the target person P to board the moving body 2 based on movement of the target person P recognized from the plurality of second images captured by the acquisition unit 25 at the prescribed time interval. For example, the determination unit 26 can determine that the target person P has the intention to board the moving body 2 when the target person P is approaching one of the doors 8 of the moving body 2 further, when the target person P stops in front of one of the doors 8 of the moving body 2, and when the target person P reaches his/her hand to a doorknob of one of the doors 8 or the like. In the example illustrated in FIG. 4, the determination unit 26 determines the presence/absence of a boarding intention of the target person P at a position at a distance D32 from the moving body 2, for example.

On the other hand, when the illuminance around the moving body 2 measured by the detection unit 24 is lower than the first prescribed value (see FIG. 3), the determination unit 26 determines whether or not the target person P has the intention to board the moving body 2 based on sensor data from the ranging sensor 4 without transmitting the image acquisition instruction to the acquisition unit 25 when the notice indicating that the target person P is detected is received from the detection unit 24.

Specifically, the determination unit 26 determines the presence/absence of the intention of the target person P to board the moving body 2 depending on whether or not the target person P has stopped within a range of a prescribed distance determined beforehand from the door of the moving body 2, based on time change of the distance from the moving body 2 to the target person P acquired from the ranging sensor 4. For example, when the target person P has stopped within the range of the prescribed distance determined beforehand from the door of the moving body 2, the determination unit 26 determines that the target person P has the intention to board the moving body 2. In the example illustrated in FIG. 3, the determination unit 26 determines the presence/absence of the boarding intention of the target person P at the position at a distance D31 which is shorter than the distance D32 illustrated in FIG. 4, for example.

Note that, even in the case where the illuminance around the moving body 2 measured by the detection unit 24 is equal to or higher than the first prescribed value, when the number of times of not recognizing that the detected object is a person exceeds a prescribed number of times in the image recognition processing performed by the detection unit 24 for the plurality of images acquired from the first camera 5 at the prescribed time interval, the determination unit 26 may determine whether or not the target person P has the boarding intention from the sensor data from the ranging sensor 4. The determination unit 26 determines the presence/absence of the boarding intention of the target person P depending on whether or not the target person P has stopped within the range of the prescribed distance determined beforehand (for example, within the range of the distance D31) from the door of the moving body 2, based on the time change of the distance from the moving body 2 to the object detected by the ranging sensor 4.

The determination unit 26 notifies the authentication unit 27 of a result of determining the presence/absence of the boarding intention for the target person P.

The authentication unit 27 authenticates that the target person P is a registered user based on the face image of the target person P extracted from the second image by the acquisition unit 25.

Specifically, when the illuminance around the moving body 2 is equal to or higher than the first prescribed value (see FIG. 4), the authentication unit 27 transmits the image acquisition instruction to the acquisition unit 25 when the notice indicating that the target person P is detected is received from the detection unit 24, and acquires the face image of the target person P repeatedly captured by the acquisition unit 25 at the prescribed time interval. Then, the target person P is authenticated by the acquired face image of the target person P.

When the illuminance around the moving body 2 is equal to or higher than the first prescribed value, the image acquisition instruction is transmitted from the authentication unit 27 to the acquisition unit 25 when the notice indicating that the target person P is detected is received from the detection unit 24, similarly to transmission of the image acquisition instruction from the determination unit 26 to the acquisition unit 25. Therefore, when the illuminance around the moving body 2 is equal to or higher than the first prescribed value, authentication of the target person P in the authentication unit 27 can be performed simultaneously with determination of the presence/absence of the boarding intention for the target person P in the determination unit 26. For example, in the example in FIG. 4, the authentication unit 27 can operate so as to complete the authentication of the target person P at the position at the distance D32 at which the determination unit 26 completes the determination on the presence/absence of the boarding intention of the target person P.

On the other hand, when the illuminance around the moving body 2 is lower than the first prescribed value (see FIG. 3), the authentication unit 27 transmits the image acquisition instruction to the acquisition unit 25 when the notice indicating that the target person P has the boarding intention is received from the determination unit 26, and acquires the face image of the target person P repeatedly captured by the acquisition unit 25 at the prescribed time interval. For example, in the example in FIG. 3, the authentication unit 27 starts and ends the authentication of the target person P in a state where the target person P virtually stands still at the position at the distance D31 at which the determination unit 26 completes the determination on the presence/absence of the boarding intention of the target person P.

The authentication of the target person P based on the face image in the authentication unit 27 may be performed as follows, for example.

The authentication unit 27 calculates a feature amount of the face image for the face image acquired by the acquisition unit 25, and calculates, for each registered user, a collation score indicating a degree of coincidence between the calculated feature amount (target feature amount, hereinafter) and a feature amount (authentication feature amount, hereinafter) of the face image preserved in the authentication data 23 of each registered user stored in the memory 21.

Then, the authentication unit 27 determines whether or not the target person P is one of the registered users based on the calculated collation scores. Specifically, for example, when there are collation scores equal to or higher than a first prescribed value in the calculated collation scores, the authentication unit 27 authenticates that the target person P is the registered user corresponding to the collation score indicating a highest value among the collation scores equal to or higher than the first prescribed value. Thus, the authentication for the target person P becomes a success.

On the other hand, when there are not the collation scores equal to or higher than the first prescribed value in the calculated collation scores, the authentication unit 27 determines that the target person P is not a registered user. Thus, the authentication for the target person P becomes a failure.

Here, the authentication unit 27 may calculate the collation score for each of the plurality of face images of the target person P extracted respectively from the plurality of images acquired by the acquisition unit 25 at the prescribed time interval, and determine presence/absence of the registered user corresponding to the target person P based on the calculated collation score. In this case, when the registered user corresponding to the target person P determined for each of the plurality of face images is the same one registered user with a possibility of a predetermined value or higher in the plurality of face images, the authentication unit 27 may determine that the target person P is the one registered user. When the one registered user cannot be specified, the authentication unit 27 can determine that the target person P is not a registered user.

In the case where the illuminance around the moving body 2 is equal to or higher than the first prescribed value, when authenticating the target person P, the authentication unit 27 may perform so-called liveness determination on whether or not the face image acquired for the target person P is an image of an actual face of the target person P. When it is determined that the acquired face image is not the image of the actual face of the target person P himself/herself and is, for example, an image of a head part of a third person wearing a mask on which a face photo is printed or the like in the liveness determination, the authentication unit 27 may determine that the authentication using the face image is a failure.

Specifically, the authentication unit 27 may authenticate whether or not the target person P is a registered user based on the face images on condition that respective hues of the face images extracted from each of the plurality of images successively captured from the second camera 6 by the detection unit 24 at the prescribed time interval and/or time-sequential brightness distribution change of the face images satisfies a predetermined standard, for example. Here, the standard may be that the hue that the face image has is not the hue peculiar to a printed matter and/or that illumination to the face of the target person P recognized from the plurality of time-sequential face images successively changes without inconsistency, or the like.

Thus, for example, it is possible to effectively prevent the target person P who intends to perform unauthorized entry into the moving body 2, for example, by wearing a mask printed with a face image of a registered user who is a different person.

The control unit 28 controls the operation of the moving body 2.

When the authentication of the target person P is a success in the authentication unit 27, the control unit 28 instructs the door switch 9 of the moving body 2 to automatically unlock the door 8. At the time, the control unit 28 may instruct the door switch 9 to automatically open the door 8 after the door 8 is unlocked. The control unit 28 may execute automatic unlocking and an automatic opening operation with the door 8 closest to the target person P as a target, for example. The door 8 closest to the target person P can be specified from the lately acquired second image and notified to the control unit 28 by the acquisition unit 25, for example.

### [3. Operation of Entry System]

Next, a procedure of the operation of the entry system 1 will be described.

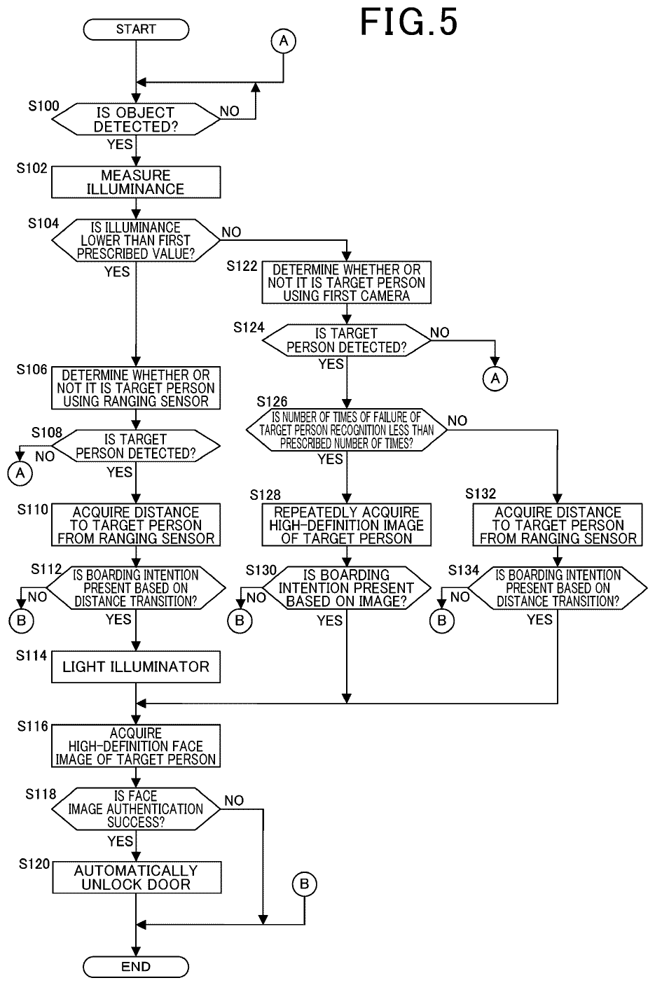

FIG. 5 is a flowchart illustrating a procedure of an entry control method executed by a computer of the entry system 1. The computer of the entry system 1 is the processor 20 of the entry controller 3 as an example in the present embodiment.

Processing illustrated in FIG. 5 is started when power sources of respective instruments illustrated in FIG. 2 including the entry controller 3 are turned on, and is repeatedly executed.

When the processing is started, first, the detection unit 24 determines whether or not an object is detected within the range of the prescribed distance from the moving body 2 by the ranging sensor 4 (S100). When the object is not detected (S100, NO), the detection unit 24 returns to step S100 to repeat the processing, and stands by for object detection.

On the other hand, when an object is detected within the range of the prescribed distance from the moving body 2 (S100, YES), the detection unit 24 measures the illuminance around the moving body 2 by the first camera 5 (S102). Hereinafter, the object that is detected is referred to as a detected object.

The detection unit 24 determines whether or not the measured illuminance around the moving body 2 is lower than the first prescribed value (S104). Then, when the illuminance around the moving body 2 is lower than the first prescribed value (S104, YES), the detection unit 24 selects the ranging sensor 4 as a sensor to be used to determine whether or not the detected object is the target person P. That is, the detection unit 24 determines whether or not the detected object is the target person P using the ranging sensor 4 (S106). When it is determined that the detected object is the target person P, the detection unit 24 transmits the notice indicating that the target person P is detected to the determination unit 26 and the authentication unit 27.

When the target person P is not detected as a result of the determination in step S106 (S108, NO), the detection unit 24 returns to step S100 to repeat the processing.

On the other hand, when the target person P is detected (S108, YES), the determination unit 26 acquires a distance from the moving body 2 to the target person P from the ranging sensor 4 (S110). Then, the determination unit 26 determines whether or not the target person P has the intention to board the moving body 2 based on a time transition of the distance from the moving body 2 to the target person P acquired from the ranging sensor 4, as described above (S112). The result of determining the presence/absence of the boarding intention is sent from the determination unit 26 to the authentication unit 27.

Then, when the target person P does not have the intention to board the moving body 2 (S112, NO), the determination unit 26 ends the present processing.

On the other hand, when the target person P has the intention to board the moving body 2 (S112, YES), the authentication unit 27 transmits the image acquisition instruction to the acquisition unit 25. In response, the acquisition unit 25 lights the illuminator 7 near the target person P (S114), then acquires a high-definition face image of the target person P, and transmits the high-definition face image to the authentication unit 27 (S116). The authentication unit 27 authenticates the target person P based on the face image of the target person P received from the acquisition unit 25, and transmits the result of the authentication to the control unit 28.

Subsequently, the control unit 28 determines whether or not the authentication of the target person P in the authentication unit 27 is a success (S118). Then, when the authentication of the target person P is a success (S118, YES), the control unit 28 instructs the door switch 9 to automatically unlock the door 8 (S120), and ends the present processing.

On the other hand, when the authentication of the target person P is not a success in step S118 (S118, NO), the control unit 28 ends the present processing without unlocking the door 8.

Meanwhile, when the illuminance around the moving body 2 is equal to or higher than the first prescribed value in step S104 (S104, NO), the detection unit 24 selects the first camera 5 as a sensor to be used to determine whether or not the detected object is the target person P. That is, the detection unit 24 determines whether or not the detected object is the target person P from the image from the first camera 5 (S106). When it is determined that the detected object is the target person P, the detection unit 24 transmits the notice indicating that the target person P is detected to the determination unit 26 and the authentication unit 27.

When the target person P is not detected as a result of the determination in step S122 (S124, NO), the detection unit 24 returns to step S100 to repeat the processing.

On the other hand, when the target person P is detected (S122, YES), the determination unit 26 determines whether or not the number of times of not recognizing that the detected object is a person (hereinafter, referred to as the number of times of a failure in target person recognition) is less than the prescribed number of times determined beforehand in the image recognition processing performed by the detection unit 24 for the plurality of images acquired from the first camera 5 at the prescribed time interval (S126).

Then, when the number of times of the failure in the target person recognition is less than the prescribed number of times (S126, YES), the determination unit 26 transmits the image acquisition instruction to the acquisition unit 25, and repeatedly acquires the high-definition image of the target person P acquired at the prescribed time interval (S128). The determination unit 26 determines whether or not the target person P has the intention to board the moving body 2 based on the acquired high-definition image of the target person P (S130). The determination unit 26 transmits a notice of the determination result to the authentication unit 27.

Then, when the target person P does not have the boarding intention (S130, NO), the determination unit 26 ends the present processing.

On the other hand, when the target person P has the boarding intention (S130, YES), the authentication unit 27 transmits the image acquisition instruction to the acquisition unit 25, and moves the processing to step S116.

Further, on the other hand, when the number of times of the failure in the target person recognition is equal to or more than the prescribed number of times in step S126 (S126, NO), the determination unit 26 acquires the distance from the moving body 2 to the target person P from the ranging sensor 4 similarly to the time when the illuminance around the moving body 2 is lower than the first prescribed value (S132). Then, the determination unit 26 determines whether or not the target person P has the intention to board the moving body 2 based on the time transition of the distance from the moving body 2 to the target person P acquired from the ranging sensor 4 (S134). The result of determining the presence/absence of the boarding intention is sent from the determination unit 26 to the authentication unit 27.

Then, when the target person P does not have the boarding intention (S134, NO), the determination unit 26 ends the present processing.

On the other hand, when the target person P has the boarding intention (S134, YES), the authentication unit 27 transmits the image acquisition instruction to the acquisition unit 25, and moves the processing to step S116.

After the present processing is ended, the processor 20 of the entry controller 3 repeats the processing from step S100 anew.

Here, in FIG. 5, the processing from step S100 to step S108 and the processing of steps S122 and S124 correspond to a detection step in the present disclosure. Further, the processing of steps S116 and S118 correspond to an authentication step in the present disclosure.

Note that the present invention is not limited to the configuration of the embodiment described above, and can be implemented in various modes without deviating from the gist.

### [5. Configurations Supported by Embodiment Described Above]

The embodiment described above supports the following configurations.
(Configuration 1) An entry system including: a detection unit configured to detect a target person approaching a moving body; and an authentication unit configured to authenticate that the target person is a registered user based on a face image of the target person, wherein the detection unit measures illuminance around the moving body when an object which has entered a range of a prescribed distance from the moving body is detected, and selects a sensor to be used to determine whether or not the object is the target person according to the illuminance.

According to the entry system of configuration 1, since the sensor capable of appropriately performing a detecting operation according to brightness around the moving body is selected and used, power is not unnecessarily consumed by a sensor not suitable for a dark place. Therefore, according to the entry system of configuration 1, a user can be appropriately authenticated while suppressing power consumption even in a dark place.
(Configuration 2) The entry system according to configuration 1, wherein the moving body includes a ranging sensor and a first camera, and the detection unit detects an object which has entered the prescribed distance range from the moving body by the ranging sensor, and measures the illuminance around the moving body by the first camera.

According to the entry system of configuration 2, since the object to the moving body is detected by the ranging sensor capable of being operated with appropriate sensitivity even in a dark place and the surrounding illuminance is measured by the camera usable also for acquisition of visual information, the approach of the target person can be appropriately detected even in a dark place and the illuminance to be a reference for proper sensor use can be easily measured without providing an additional sensor for illuminance measurement.
(Configuration 3) The entry system according to configuration 2, wherein the detection unit, when the illuminance around the moving body is lower than a first prescribed value determined beforehand, selects the ranging sensor as a sensor to be used to determine whether or not the object is the target person, acquires a distance from the moving body to the object by the ranging sensor at a prescribed time interval, and determines that the object is the target person when a moving speed of the object is in a prescribed range determined beforehand and the distance between the object and the moving body is decreasing with time.

According to the entry system of configuration 3, in the case where it is dark around the moving body, the ranging sensor suitable for an operation in a dark place is used to not only detect the object but also determine whether or not the object is the target person approaching the moving body. Therefore, in the entry system of configuration 3, since the camera is not used to determine the approach of the target person in a dark place, illumination or the like for securing the illuminance is not used, and the target person can be appropriately detected while suppressing the power consumption even in a dark place.
(Configuration 4) The entry system according to configuration 3, wherein the detection unit, when the illuminance around the moving body is equal to or higher than the first prescribed value, selects the first camera as a sensor to be used to determine whether or not the object is the target person, and determines that the object is the target person when it can be recognized that the object is a person and it is determined that the person is moving in a direction of approaching the moving body, based on an image of the object acquired from the first camera at a prescribed time interval.

According to the entry system of configuration 4, when it is bright around the moving body, the target person approaching the moving body is detected based on the visual information acquired from the camera so that the approach of the target person can be quickly detected.
(Configuration 5) The entry system according to configuration 3 or 4, wherein the moving body includes a second camera having a resolution higher than a resolution of the first camera, the entry system further including: an acquisition unit configured to acquire an image of the target person by the second camera at a prescribed time interval when the target person is detected; and a determination unit configured to determine presence/absence of a boarding intention of the target person to the moving body, wherein the determination unit determines the presence/absence of the boarding intention of the target person based on the image of the target person acquired from the second camera, when the illuminance measured by the detection unit is equal to or higher than the first prescribed value, and determines the presence/absence of the boarding intention of the target person depending on whether or not the target person has stopped within a prescribed distance from a door of the moving body based on time change of the distance from the moving body to the target person acquired from the ranging sensor, when the illuminance measured by the detection unit is lower than the first prescribed value.

According to the entry system of configuration 5, when it is bright around the moving body, the boarding intention of the target person can be accurately determined by the image of higher definition than the image used to detect the target person. On the other hand, when it is dark around the moving body, the boarding intention of the target person can be determined by the ranging sensor without unnecessarily consuming power by using a high-resolution camera not suitable for a dark place so that the boarding intention of the target person can be appropriately determined while suppressing the power consumption even in a dark place.
(Configuration 6) The entry system according to configuration 5, wherein the moving body includes an illuminator which illuminates an imaging range of the second camera, the acquisition unit lights the illuminator when the illuminance detected by the detection unit is lower than a prescribed value, and the authentication unit authenticates that the target person is a registered user based on the face image of the target person acquired from the second camera.

According to the entry system of configuration 6, since the illuminator is lighted at start of a phase of authenticating the target person who has approached the moving body in a dark place, the target person can be appropriately authenticated even in a dark place while suppressing power consumption by limiting an operating period of the illuminator.
(Configuration 7) The entry system according to any one of configurations 2 to 6, wherein the detection unit changes exposure setting of the first camera when the measured illuminance is equal to or higher than a second threshold.

According to the entry system of configuration 7, since exposure sensitivity of the first camera is set according to the surrounding brightness, blown out highlights are prevented from being generated in the image acquired by the first camera, and the target person approaching the moving body can be appropriately determined.
(Configuration 8) The entry system according to any one of configurations 2 to 7, wherein the ranging sensor is a radar.

According to the entry system of configuration 8, the radar whose detection accuracy is not to be lowered even in a dark place is used as the ranging sensor, and the object approaching the moving body can be accurately detected.
(Configuration 9) The entry system according to any one of configurations 5 to 8, wherein the determination unit determines the presence/absence of the boarding intention of the target person depending on whether or not the target person has stopped within the prescribed distance from the door of the moving body based on the time change of the distance from the moving body to the target person, the distance being acquired from the ranging sensor, when a number of times of not recognizing that the object is a person exceeds a prescribed number of times for a plurality of images acquired from the first camera at a prescribed time interval in the detection unit, in a case where the illuminance is equal to or higher than a first threshold.

According to the entry system of configuration 9, even in the case where it is bright around the moving body above a prescribed level, when results of the image recognition processing for the plurality of images from the camera vary, the boarding intention of the target person can be detected using the ranging sensor.
(Configuration 10) An authentication method conducted by a computer of an entry system which authenticates a target person approaching a moving body, the method including: a detection step of detecting the target person approaching the moving body; and an authentication step of authenticating that the target person is a registered user based on a face image of the target person, wherein, in the detection step, illuminance around the moving body is measured when an object which has entered a range of a prescribed distance from the moving body is detected, and a sensor to be used to determine whether or not the object is the target person is selected according to the illuminance.

According to the authentication method of configuration 10, even in the case where it is dark around the moving body, the user can be appropriately authenticated while suppressing the power consumption.

### REFERENCE SIGNS LIST

1 . . . entry system, 2 . . . moving body, 3 . . . entry controller, 4 . . . ranging sensor, 4a . . . right ranging sensor, 4b . . . left ranging sensor, 4c . . . rear ranging sensor, 5 . . . first camera, 5a . . . first right camera, 5b . . . first left camera, 5c . . . first rear camera, 6 . . . second camera, 6a . . . second right camera, 6b . . . second left camera, 6c . . . second rear camera, 7 . . . illuminator, 7a . . . right illuminator, 7b . . . left illuminator, 7c . . . rear illuminator, 8 . . . door, 8a . . . driver's seat door, 8b . . . right rear seat door, 8c . . . passenger seat door, 8d . . . left rear seat door, 8e . . . back door, 9 . . . door switch, 9a . . . right front door switch, 9b . . . right rear door switch, 9c . . . left front door switch, 9d . . . left rear door switch, 9e . . . back door switch, 10 . . . communication device, 20 . . . processor, 21 . . . memory, 22 . . . program, 23 . . . authentication data, 24 . . . detection unit, 25 . . . acquisition unit, 26 . . . determination unit, 27 . . . authentication unit, 28 . . . control unit.

1. An entry system comprising:
a detection unit configured to detect a target person approaching a moving body; and
an authentication unit configured to authenticate that the target person is a registered user based on a face image of the target person,
wherein the detection unit
measures illuminance around the moving body when an object which has entered a range of a prescribed distance from the moving body is detected, and
selects a sensor to be used to determine whether or not the object is the target person according to the illuminance.

2. The entry system according to claim 1,
wherein the moving body includes a ranging sensor and a first camera, and
the detection unit
detects an object which has entered the prescribed distance range from the moving body by the ranging sensor, and
measures the illuminance around the moving body by the first camera.

3. The entry system according to claim 2,
wherein the detection unit, when the illuminance around the moving body is lower than a first prescribed value determined beforehand,
selects the ranging sensor as a sensor to be used to determine whether or not the object is the target person,
acquires a distance from the moving body to the object by the ranging sensor at a prescribed time interval, and determines that the object is the target person when a moving speed of the object is in a prescribed range determined beforehand and the distance between the object and the moving body is decreasing with time.

4. The entry system according to claim 3,
wherein the detection unit, when the illuminance around the moving body is equal to or higher than the first prescribed value,
selects the first camera as a sensor to be used to determine whether or not the object is the target person, and
determines that the object is the target person when it can be recognized that the object is a person and it is determined that the person is moving in a direction of approaching the moving body, based on an image of the object acquired from the first camera at a prescribed time interval.

5. The entry system according to claim 3,
wherein the moving body includes a second camera having a resolution higher than a resolution of the first camera,
the entry system further comprising:
an acquisition unit configured to acquire an image of the target person by the second camera at a prescribed time interval when the target person is detected; and
a determination unit configured to determine presence/absence of a boarding intention of the target person to the moving body,
wherein the determination unit
determines the presence/absence of the boarding intention of the target person based on the image of the target person acquired from the second camera, when the illuminance measured by the detection unit is equal to or higher than the first prescribed value, and
determines the presence/absence of the boarding intention of the target person depending on whether or not the target person has stopped within a prescribed distance from a door of the moving body based on time change of the distance from the moving body to the target person acquired from the ranging sensor, when the illuminance measured by the detection unit is lower than the first prescribed value.

6. The entry system according to claim 5,
wherein the moving body includes an illuminator which illuminates an imaging range of the second camera,
the acquisition unit lights the illuminator when the illuminance detected by the detection unit is lower than a prescribed value, and
the authentication unit authenticates that the target person is a registered user based on the face image of the target person acquired from the second camera.

7. The entry system according to claim 2,
wherein the detection unit changes exposure setting of the first camera when the measured illuminance is equal to or higher than a second threshold.

8. The entry system according to claim 2,
wherein the ranging sensor is a radar.

9. The entry system according to claim 5,
wherein the determination unit
determines the presence/absence of the boarding intention of the target person depending on whether or not the target person has stopped within the prescribed distance from the door of the moving body based on the time change of the distance from the moving body to the target person, the distance being acquired from the ranging sensor, when a number of times of not recognizing that the object is a person exceeds a prescribed number of times for a plurality of images acquired from the first camera at a prescribed time interval in the detection unit, in a case where the illuminance is equal to or higher than a first threshold.

10. An authentication method conducted by a computer of an entry system which authenticates a target person approaching a moving body, the method comprising:
a detection step of detecting the target person approaching the moving body; and
an authentication step of authenticating that the target person is a registered user based on a face image of the target person,
wherein, in the detection step,
illuminance around the moving body is measured when an object which has entered a range of a prescribed distance from the moving body is detected, and
a sensor to be used to determine whether or not the object is the target person is selected according to the illuminance.
